(19) United States
(12) Patent Application Publication
(10) Pub. No.: US 2019/0194986 A1
(43) Pub. Date: Jun. 27, 2019

(54) HANDLE HAVING AIRTIGHTNESS FUNCTION USED FOR CASING OF NEGATIVE PRESSURE TYPE DUST COLLECTOR

(71) Applicant: SAN FORD MACHINERY CO., LTD., Taichung (TW)

(72) Inventor: Yuan-Tai CHENG, TAICHUNG (TW)

(21) Appl. No.: 15/854,574

(22) Filed: Dec. 26, 2017

(51) Int. Cl. E05C 9/08; E05B 65/00; E05C 9/18; E05C 9/10; B01D 46/00

(52) U.S. Cl. CPC E05C 9/08; E05B 65/001; B01D 46/0093; E05C 9/10; B01D 46/0005; E05C 9/1808

(57) ABSTRACT

A handle having an airtightness function used for a casing of a negative pressure type dust collector is provided. Two pivot seats are fixed to a door of the casing and vertically aligned with each other. A rotating shaft is pivotally connected to the pivot seats. Two ends of the rotating shaft are provided with eccentric blocks, respectively. Two engaging blocks are located close to the outer periphery of the door and vertically aligned with each other. The eccentric blocks are engaged with the engaging blocks to exert a force to the door so that the door is closely attached to the casing, thereby enhancing the airtight effect of the casing and preventing the door from being deformed due to backwash and preventing the dust from flowing out through the gap between the door and the casing to cause secondary environmental pollution.

### FIELD OF THE INVENTION

The present invention relates to a dust collector, and more particularly, to a handle having an airtightness function used for a casing of a negative pressure type dust collector.

### BACKGROUND OF THE INVENTION

A conventional negative pressure type dust collector includes a casing. The casing is provided with a filter, a dust collection container and a blower therein. Wherein, one side of the casing is provided with an air inlet corresponding to the filter. The top of the casing is provided with an air outlet. The blower is located above the filter. The dust collection container is located under the filter. Through the running of the blower, the inside of the casing is in a negative pressure state, so that the air with dust is inhaled into the casing. The blower guides the air to pass through the filter, and the dust is adsorbed on the filter, and finally the air flows out through the air outlet, thereby purifying and filtering the air. When the dust collector is used for a period of time, a large amount of dust is adsorbed on the outer peripheral wall of the filter. Therefore, it is necessary to clean the filter. A backwash device is installed above the filter. The backwash device ejects a high-pressure gas towards the filter so that the dust is removed from the filter and falls into dust collection container. The filter can be cleaned quickly and conveniently.

One side of the casing of the conventional negative pressure type dust collector is provided with a door for the user to replace and maintain the filter, the dust collection container and the blower in the casing. The door is secured to the casing with a plurality of bolts. Therefore, when the backwash device instantaneously generates the high-pressure gas, the door is easily deformed to form a gap between the door and the casing to affect the negative pressure in the casing. When the backwash device ejects the high-pressure gas towards the filter, the dust will flow out through the gap between the door and the casing to result in secondary environmental pollution. Accordingly, the inventor of the present invention has devoted himself based on his many years of practical experiences to solve these problems.

### SUMMARY OF THE INVENTION

The primary object of the present invention is to provide a handle having an airtightness function used for a casing of a negative pressure type dust collector to improve the airtight effect of the casing and prevent the door from being deformed due to backwash. The prevent invention can prevent the dust from flowing out through the gap between the door and the casing to cause secondary environmental pollution.

In order to achieve the aforesaid object, a handle of a casing of a negative pressure type dust collector is provided. One side of the dust collector is provided with a door. The handle is disposed on the door. The handle comprises two pivot seats, a rotating shaft, and two engaging blocks. The pivot seats are fixed to an outer side of the door and vertically aligned with each other. The pivot seats each include a first pivot member and a second pivot member. Two ends of the first pivot member are fixed to the door. A middle of a top surface of the first pivot member is formed with a recess. Two ends of the second pivot member are fixed to the two ends of the first pivot member. A middle of the second pivot member is formed with a groove. The groove is sleeved on the first pivot member. The rotating shaft is pivotally disposed between the recess and the groove of the two pivot seats. An outer peripheral wall of the rotating shaft is provided with two positioning rings corresponding to the pivot seats. The positioning rings abut against the two pivot seats, respectively. Two ends of the rotating shaft are provided with eccentric blocks, respectively. Each of the eccentric blocks has an extension portion extending along a tangent line thereof. An inner side of the extension portion is formed with a first contact surface. A middle portion of the rotating shaft is provided with an operating lever. The engaging blocks are fixed on the casing and vertically aligned with each other and located close to an outer periphery of the door. A top surface of each of the engaging blocks is provided with a hook. An inner side wall of the hook has a second contact surface. An inner side of the hook is formed with a pivot space. A bottom of each of the eccentric blocks is provided with a fixing seat for the engaging blocks to be fixed on the casing.

Through the handle of the casing of the negative pressure type dust collector provided by the present invention, the eccentric blocks of the rotating shaft are engaged with the engaging blocks so that the door is closely attached to the casing, thereby enhancing the airtight effect of the casing and preventing the door from being deformed due to backwash. The prevent invention can prevent the dust from flowing out through the gap between the door and the casing to cause secondary environmental pollution.

### BRIEF DESCRIPTION OF THE DRAWINGS

FIG. 1 a perspective view in accordance with a preferred embodiment of the present invention;

FIG. 2 a side view in accordance with the preferred embodiment of the present invention;

FIG. 3 is an exploded view of the handle of the present invention;

FIG. 4 is a schematic view of the present invention when in use, showing the rotating shaft to be disengaged from the operating lever fixing seat;

FIG. 5 is a schematic view of the present invention when in use, showing the rotating shaft before turned;

FIG. 6 is a schematic view of the present invention when in use, showing the rotating shaft to be unlocked; and

FIG. 7 is a schematic view of the present invention when in use, showing that the rotating shaft is unlocked to open the door.

### DETAILED DESCRIPTION OF THE PREFERRED EMBODIMENTS

Embodiments of the present invention will now be described, by way of example only, with reference to the accompanying drawings.

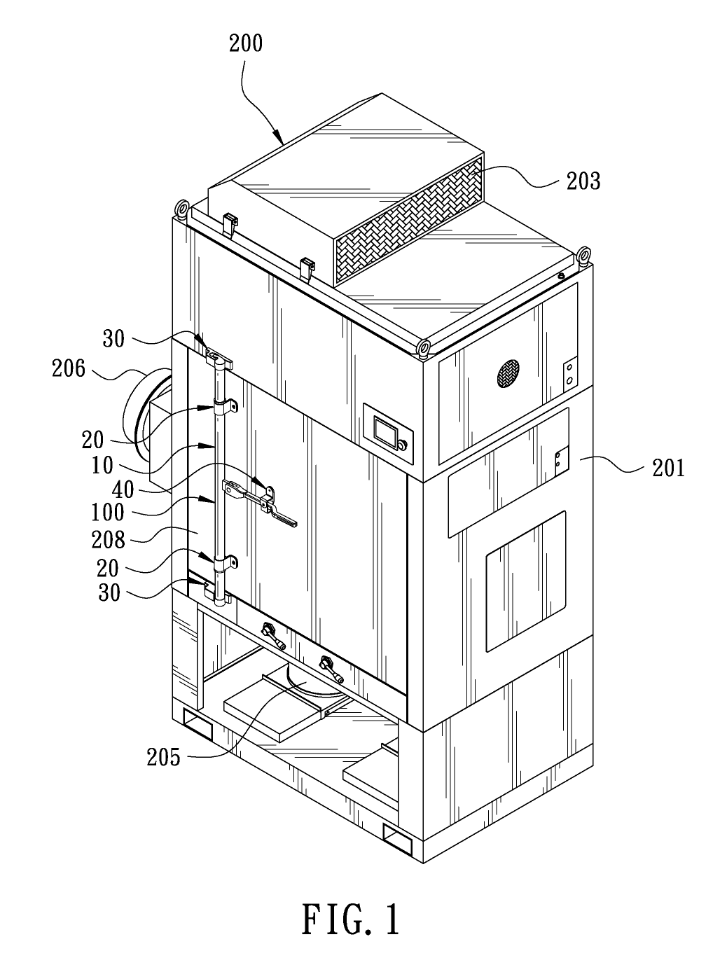

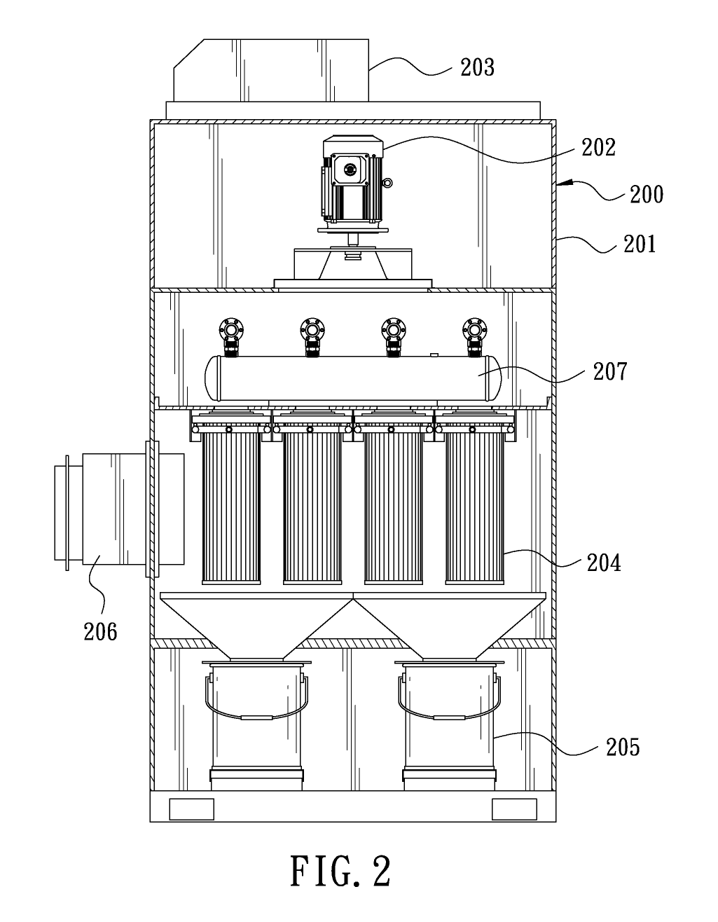

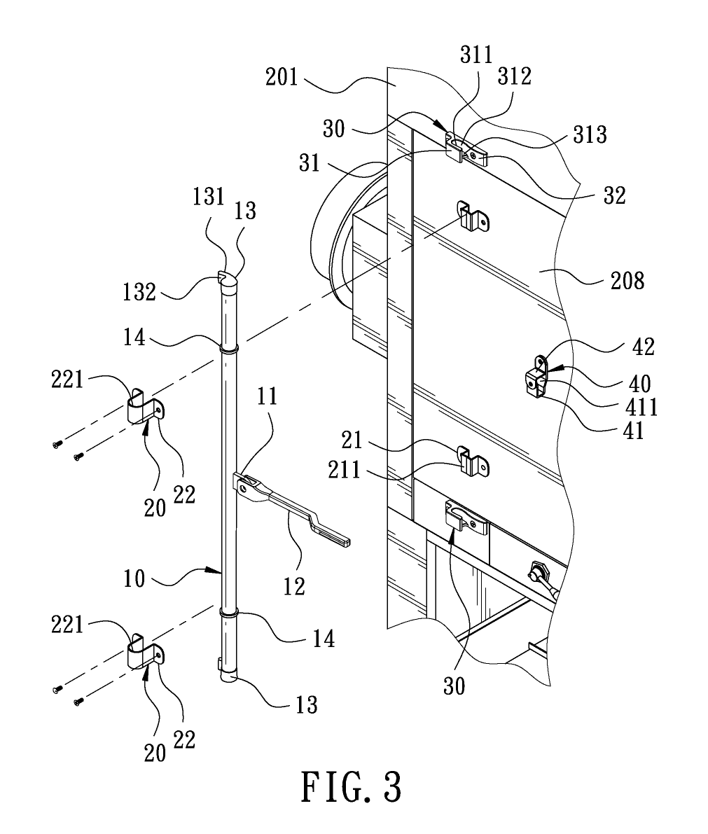

As shown in FIG. 1 to FIG. 3, the present invention discloses a handle having an airtightness function used for a casing of a negative pressure type dust collector. The dust collector 200 comprises a casing 201. A blower 202 is provided in the upper portion of the casing 201. The top of the casing 201, corresponding in position to the blower 202, is provided with an air outlet 203. The middle portion of the casing 201 is provided with a plurality of filters 204. A plurality of dust collection containers 205 are provided under the filters 204. One side of the casing 201 is provided with an air inlet 206 corresponding to the filters 204. A backwash device 207 is provided above the filters 204. Another side of the casing 201 is provided with a door 208. A handle 100 is provided on the door 208. The handle 100 comprises a rotating shaft 10, two pivot seats 20, two engaging blocks 30, and an operating lever fixing seat 40.

The rotating shaft 10 is disposed on the outer side of the door 208. A pivot portion 11 radially extends from the middle of the rotating shaft 10. The pivot portion 11 is pivotally connected with an operating lever 12. Two ends of the rotating shaft 10 are provided with eccentric blocks 13, respectively. Each eccentric block 13 has an extension portion 131 extending along a tangent line thereof. An inner side of the extension portion 131 is formed with a first contact surface 132. The outer peripheral wall of the rotating shaft 10 is provided with two positioning rings 14.

The two pivot seats 20 are fixed to the outer side of the door 208 and vertically aligned with each other. Each pivot seat 20 includes a first pivot member 21 and a second pivot member 22. Wherein, two ends of the first pivot member 21 are fixed to the door 208. The middle of the top surface of the first pivot member 21 is formed with a recess 211. Two ends of the second pivot member 22 are fixed to the two ends of the first pivot member 21. The middle of the second pivot member 22 is formed with a groove 221. The groove 221 is sleeved on the first pivot member 21, so that the rotating shaft 10 is pivotally disposed between the recess 211 and the groove 221. The positioning rings 14 of the rotating shaft 10 abut against the respective sides of the pivot seats 20, so that the rotating shaft 10 is positioned on the two pivot seats 20.

The two engaging blocks 30 are fixed on the casing 201 and vertically aligned with each other, and are located close to the outer periphery of the door 208. The top surface of each engaging block 30 is provided with a hook 31. The inner side wall of the hook 31 has a second contact surface 311. An inner side of the hook 31 is formed with a pivot space 312. The engaging block 30 has an h-shaped cross section. A bottom plate 313 is provided below the pivot space 312. When the eccentric block 13 of the rotating shaft 10 is disposed in the pivot space 312, the bottom surface of the eccentric block 13 abuts against the top of the bottom plate 313. In addition, one side of each engaging block 30, facing the casing 201, is provided with a fixing seat 32 fixed on the casing 201 by a bolt.

The operating lever fixing seat 40 includes a first fixing member 41 and a second fixing member 42. Wherein, one end of the first fixing member 41 is fixed to the door 208. Another end of the first fixing member 41 is a U-shaped plate with an opening facing upward so that the first fixing member 41 has an accommodation trough 411. One end of the second fixing member 42 is pivotally connected to the first fixing member 41 for the accommodation trough 411 to be in a closed state, so that the operating lever 12 can be disposed in the accommodation trough 411.

Referring to FIG. 1 to FIG. 3, first, the rotating shaft 10 is rotated by the operating lever 12, and the extension portions 131 of the eccentric blocks 13 are simultaneously turned to the pivot spaces 312 of the engaging blocks 30 so that the first contact surfaces 132 of the eccentric blocks 13 are pressed against the second contact surfaces 311 of the engaging blocks 30 for the door 208 to be closely attached to the casing 201, thereby improving the airtight effect of the casing 201. After that, the dust collector 200 can be started to run. The casing 201 of the dust collector 200 is in a negative pressure state, such that the air with dust can be inhaled into the casing 201 to perform the filtering operation. The dust filtering operation is the prior art and won't be described hereinafter. When the dust collector 200 is used for a period of time, the backwash device 207 will generate a high-pressure gas towards the filters 204 so that the dust on the filters 204 will fall down. When the backwash device 207 instantaneously generates the high-pressure gas, the handle 100 can hold the door 208 so that the door 208 is still closely attached to the casing 201.

It is worth mentioning that when the dust collector 200 is used for a period of time, the door 208 may be deformed due to the instantaneous high-pressure gas generated by the backwash device 207, so that a gap is formed between the door 208 and the casing 201. The extension portions 131 of the eccentric blocks 13 are interlocked with the hooks 31 of the engaging blocks 30, so that the rotating shaft 10 exerts a force to push the door 208 towards the casing 201, enabling the door 208 to be closely attached to the casing 201 so as to reduce the gap between the door 208 and the casing 201. In the case of a gas explosion generated in the casing 201, the door 208 won't disengage from the casing 201 to cause damages to the surrounding objects and equipment or to injure the person. In addition, the prevent invention can prevent the dust from flowing out through the gap between the door 208 and the casing 201 to cause secondary environmental pollution.

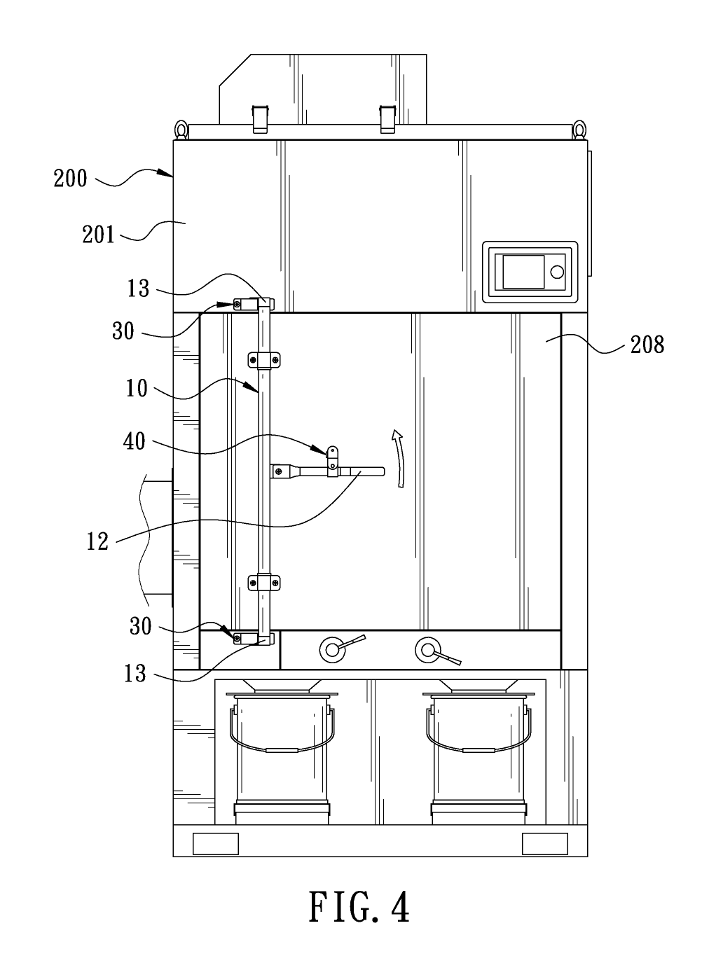

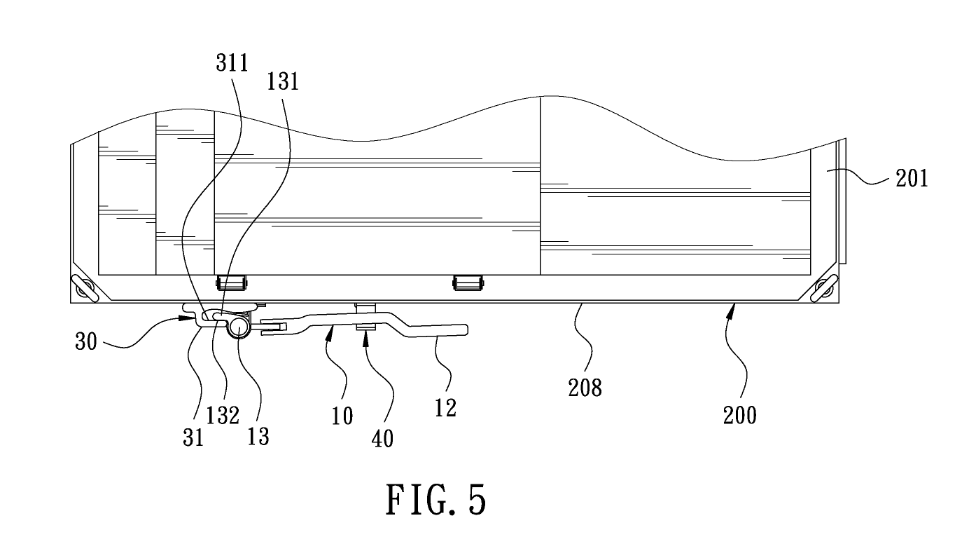

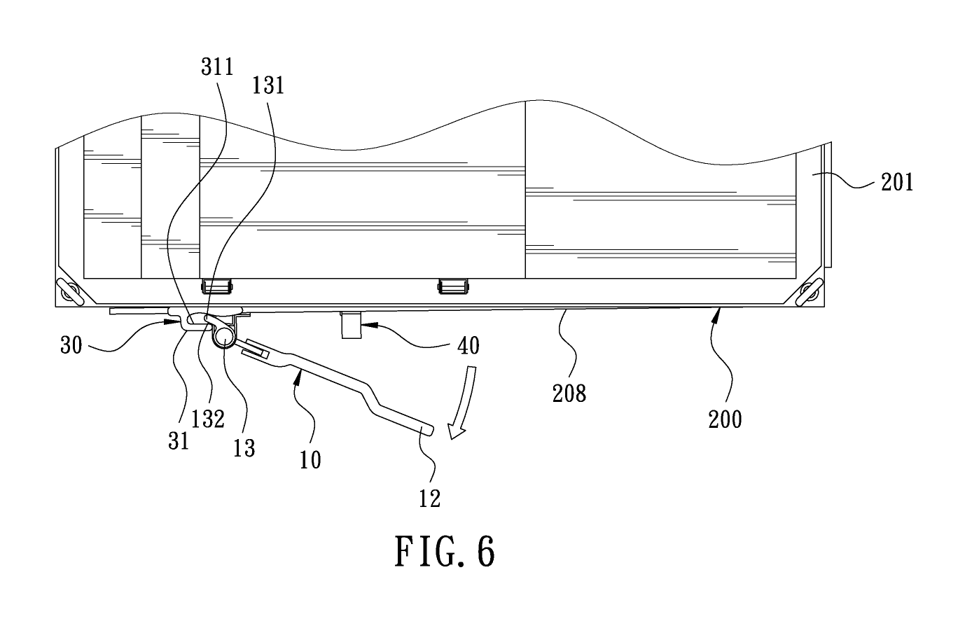

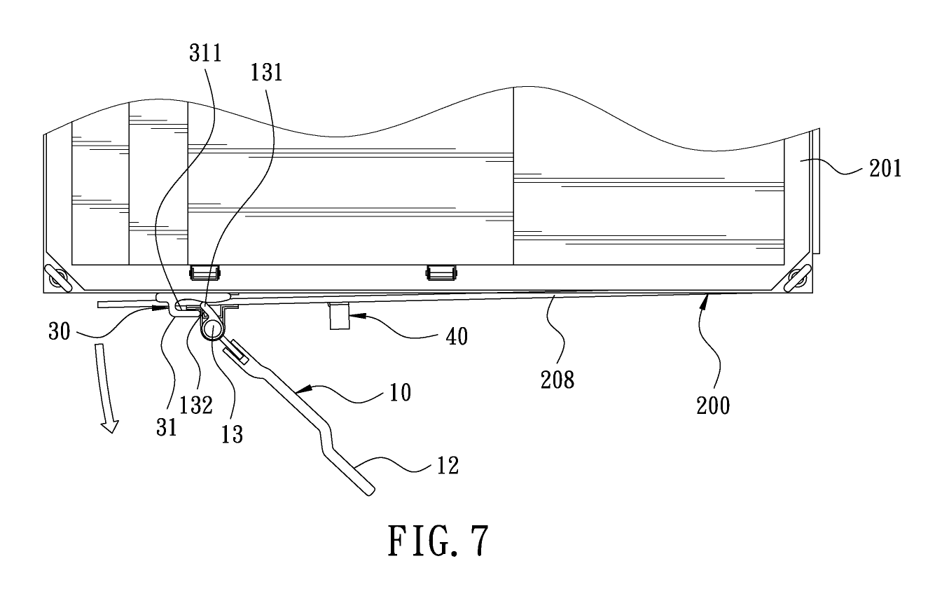

Referring to FIG. 4 and FIG. 5, when the dust collector 200 is used for a period of time, the blower 202, the filters 204 and the backwash device 208 in the casing 201 need to be replaced or maintained. The operating lever 12 is pulled up to disengage the operating lever 12 from the operating lever fixing seat 40, and then the rotating shaft 10 is driven to rotate by the operating lever 12. As shown in FIG. 6, the operating lever 12 is turned clockwise to drive the rotating shaft 10 to rotate, meanwhile, the extension portions 131 of the eccentric blocks 13 are moved away from the pivot spaces 312 of the engaging blocks 30 and the first contact surface 132 and the second contact surface 311 are separated from each other. The state of tightening the door 208 is released. Referring to FIG. 7, the operating lever 12 is pulled outward to open the door 208, such that the user can replace or maintain the dust collector 200 conveniently to prolong the service life.

It is worth mentioning that the operating lever fixing seat 40 is disposed in the vicinity of the rotating shaft 10. When the eccentric blocks 13 are engaged with the engaging blocks 30, the operating lever 12 is disposed on the operating lever fixing seat 40. When the dust collector 200 is running or in the case of a gas explosion, the rotating shaft 10 won't be rotated because of vibration so as to ensure that extension portions 131 of the eccentric blocks 13 are engaged with the hooks 31 of the engaging blocks 30. The door 208 is closely attached to the casing 201 to enhance the airtight effect of the casing 201.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A handle of a casing of a negative pressure type dust collector, one side of the dust collector being provided with a door, the handle being disposed on the door, the handle comprising:
two pivot seats, fixed to an outer side of the door and vertically aligned with each other, the pivot seats each including a first pivot member and a second pivot member, two ends of the first pivot member being fixed to the door, a middle of a top surface of the first pivot member being formed with a recess, two ends of the second pivot member being fixed to the two ends of the first pivot member, a middle of the second pivot member being formed with a groove, the groove being sleeved on the first pivot member;
a rotating shaft, pivotally disposed between the recess and the groove of the two pivot seats, an outer peripheral wall of the rotating shaft being provided with two positioning rings corresponding to the pivot seats, the positioning rings abutting against the two pivot seats respectively, two ends of the rotating shaft being provided with eccentric blocks respectively, each of the eccentric blocks having an extension portion extending along a tangent line thereof, an inner side of the extension portion being formed with a first contact surface, a middle portion of the rotating shaft being provided with an operating lever;
two engaging blocks, fixed on the casing and vertically aligned with each other and located close to an outer periphery of the door, a top surface of each of the engaging blocks being provided with a hook, an inner side wall of the hook having a second contact surface, an inner side of the hook being formed with a pivot space, a bottom of each of the eccentric blocks being provided with a fixing seat for the engaging blocks to be fixed on the casing.

2. The handle of the casing of the negative pressure type dust collector as claimed in claim 1, further comprising an operating lever fixing seat, the operating lever fixing seat including a first fixing member and a second fixing member, wherein one end of the first fixing member is fixed to the door, another end of the first fixing member is a U-shaped plate with an opening facing upward so that the first fixing member has an accommodation trough, one end of the second fixing member is pivotally connected to the first fixing member for the accommodation trough to be in a closed state, so that the operating lever is disposed in the accommodation trough.

3. The handle of the casing of the negative pressure type dust collector as claimed in claim 1, wherein the engaging blocks each have an h-shaped cross section.

4. The handle of the casing of the negative pressure type dust collector as claimed in claim 1, wherein a bottom plate is provided below the pivot space of each of the engaging blocks, the bottom of each of the eccentric blocks of the rotating shaft abuts against a top of the bottom plate.
